(19) United States
(12) Patent Application Publication
(10) Pub. No.: US 2009/0278278 A1
(43) Pub. Date: Nov. 12, 2009

(54) METHOD OF PRODUCING POLYOLEFIN RESIN FILM

(76) Inventors: Kenzo Chikanari, Chiba (JP); Kazuhiro Asami, Chiba (JP)

Correspondence Address: BIRCH STEWART KOLASCH & BIRCH, PO BOX 747, FALLS CHURCH, VA, 22040-0747, US

(21) Appl. No.: 12/306,655

(22) PCT Filed: Jun. 21, 2007
(86) PCT No.: PCT/JP2007/062953

§ 371 Date: Dec. 24, 2008

(30) Foreign Application Priority Data
Jun. 27, 2006 (JP) 2006-176478

(51) Int. Cl. B29C 47/00

(52) U.S. Cl. 264/209.1

(57) ABSTRACT

A method of producing a polyolefin resin film comprising melt-extruding a polyolefin resin from a circular die toward the antigravity direction to form a tubular film and cooling the tubular film while receiving the film toward the antigravity direction, wherein a water-absorbing material containing water and having a width in the gravity direction of 5 mm or more is brought into contact with the peripheral surface of the tubular film to cool the film, at any position distant by 0 to 200 mm toward the gravity direction from the frost line obtained by air cooling.

### TECHNICAL FIELD

The present invention relates to a method of producing a polyolefin resin film.

### BACKGROUND ART

Films made of polyolefin resins such as a polyethylene resin, polypropylene resin and the like are used as films for wrapping of foods, daily miscellaneous goods and the like because of excellent strength and hygiene (for example, JP-A No. 10-237187). As the method of producing a film made of such a polyolefin resin, there are suggested a method of molding by an apparatus by which a polyolefin resin is melt-extruded toward the upper direction (antigravity direction) from a circular die to form a tubular film and the tubular film is air-cooled while receiving the film toward the upper direction, what is called an upward air-cooling mode inflation molding apparatus (for example, JP-A No. 6-114929), a method of molding by an apparatus by which a polyolefin resin is melt-extruded toward the lower direction (gravity direction) from a circular die connected to an extruder provided in an upper position to form a tubular film and the tubular film is water-cooled while receiving the film toward the lower direction, what is called a water-cooling mode inflation molding apparatus (for example, JP-A No. 9-109274), and the like.

### DISCLOSURE OF THE INVENTION

The molding method by an air-cooling mode inflation molding apparatus, however, is not necessarily satisfactory in the transparency of the resultant film. The molding method by a water-cooling mode inflation molding apparatus is more preferable in the transparency of the resultant film than the molding method by an air-cooling mode inflation molding apparatus, however, is not necessarily satisfactory in the cost of the molding apparatus since an extruder, circular die and the like are arranged in upper positions.

Under such conditions, an object to be attained by the present invention is to provide a method of producing a polyolefin resin film in which a polyolefin resin is melt-extruded toward the antigravity direction from a circular die to form a tubular film and the tubular film is cooled while receiving the film toward to antigravity direction, whereby obtaining a film excellent in transparency.

The present invention relates to a method of producing a polyolefin resin film comprising melt-extruding a polyolefin resin from a circular die toward the antigravity direction to form a tubular film and cooling the tubular film while receiving the film toward the antigravity direction, wherein a water-absorbing material containing water and having a width in the gravity direction of 5 mm or more is brought into contact with the peripheral surface of the tubular film to cool the film, at any position distant by 0 to 200 mm toward the gravity direction from the frost line obtained by air cooling.

### BRIEF EXPLANATION OF DRAWINGS

FIG. 1 is a schematic view showing one example of the present invention.

FIG. 2 is a schematic view showing another example of the present invention.

### DESCRIPTION OF MARKS

1. circular die
2. air ring apparatus
3. tubular film
4. water feeding tube
5. water feeding ring
6. contact ring for water-feeding
7. downstream water recovery ring
8. downstream water discharge tube
9. upstream water recovery ring
10. upstream water discharge tube
11. V-shaped ditch water recovery ring
12. V-shaped ditch water discharge tube

### MODES FOR CARRYING OUT THE INVENTION

As the method of melt-extruding a polyolefin resin from a circular die toward the antigravity direction to form a tubular film and receiving the tubular film toward the antigravity direction in the present invention, known methods, for example, methods using a known air-cooling mode inflation molding apparatus are mentioned. Specifically mentioned is a method in which a polyolefin resin is extruded in the form of tube under melted condition from a circular die by an extruder equipped with the circular die to give a tubular film, next, air is blown to the outer surface of the tubular film by an air ring apparatus and the tubular film is continuously received by a receiver constituted of a guide, pinch roll, winder and the like while dilating the tubular film by introducing a fluid such as air or the like into the interior thereof.

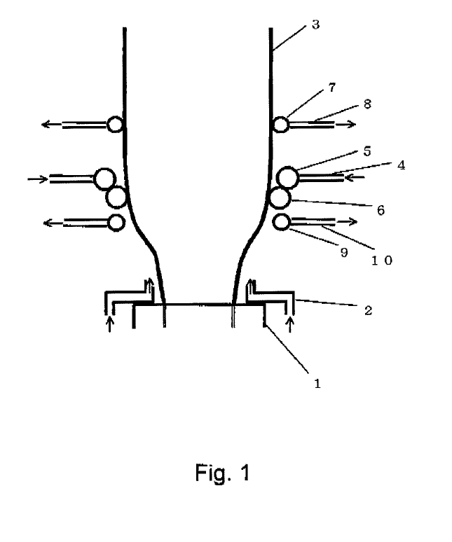

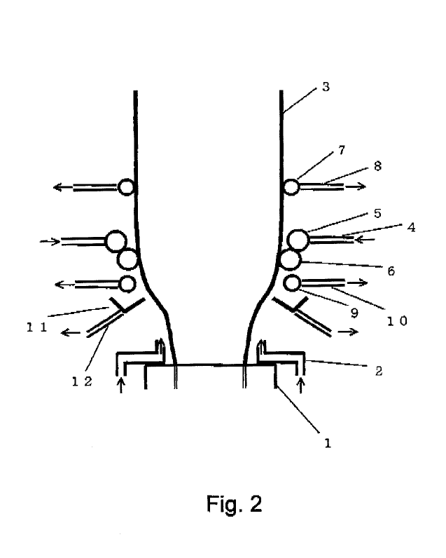

In the present invention, a water-absorbing material containing water is brought into contact with the peripheral surface of a tubular film melt-extruded toward the antigravity direction from a circular die, to cool the film with water. As the apparatus to be used in such a method, an apparatus is preferably used having a water feeding means having a water-absorbing material containing water and capable of feeding water to the peripheral surface of a tubular film from the water-absorbing material, and a water recovery means which is capable of recovering water from the peripheral surface of the tubular film. Hereinafter, one embodiment of the apparatus will be illustrated referring to FIGS. 1 and 2.

The water feeding means has a water feeding tube 4, water feeding ring 5, contact ring 6 for water feeding, and water feeding pump (not shown). The water feeding ring 5 is constituted of a circular tube and has a size at which a tubular film is capable of passing through inside of the ring without contact during film molding, and into the tube, water is fed via the water feeding tube 4 from the water feeding pump in flow rate controllable fashion. The water feeding ring 5 has a plurality of water feeding ports approximately on the inner side in the circumferential direction of the ring, and water fed from the water feeding pump is fed to the circular contact ring 6 for water feeding from the water feeding ports.

At least the surface member of the contact ring 6 for water feeding is made of a water-absorbing material, and the water-absorbing material containing water comes into contact with the peripheral surface of a tubular film and feeds water to the peripheral surface of the tubular film. The water-absorbing material constituting at least the surface member of the contact ring 6 for water feeding is not particularly restricted, and may be one which absorbs and releases water. For obtaining good sliding with the tubular film and excellent molding and processing stability in film processing and molding, it is more preferable to use a water-absorbing material which easily absorbs and releases water.

Further, the water-absorbing material is preferably a material having flexibility so that it can come into contact with the tubular film even in the case of vibration of the tubular film. As such a water-absorbing material, mentioned are cloth, nonwoven fabric, cotton, felt, quilt, water-absorbing sponge, water-absorbing sheet and the like. Among them, a nonwoven fabric sheet, water-absorbing sponge and water-absorbing sheet are preferably used. As the material constituting the nonwoven fabric sheet, thermoplastic resins are mentioned such as polyester resins, polyurethane resins, polyamide resins, polyolefin resins, polyvinyl alcohol resins, polyacrylic acid resins and the like. Among them, polyester resins and polyolefin resins are preferably used. The material constituting the water-absorbing sponge and water-absorbing sheet includes water-absorbing resins such as, for example, polyacrylic acid resins, polyvinyl alcohol resins, cellulose resins, starch resins and the like. Specific examples thereof include a starch-acrylic acid (salt) graft copolymer, saponified material of a starch-ethyl acrylate graft copolymer, saponified material of a starch-methyl methacrylate graft copolymer, saponified material of a starch-acrylonitrile graft copolymer, saponified material of a starch-acrylamide graft copolymer, saponified material of a starch-acrylonitrile-2-acrylamide-2-methylpropanesulfonic acid graft copolymer, acrylic acid (salt) polymer, polyethylene oxide cross-linked with acrylic acid, cross-linked material of sodium carboxymethyl cellulose, cross-linked material of polyvinyl alcohol-maleic anhydride reaction product, and the like. Of them, water-absorbing sponges and water-absorbing sheets made of polyacrylic acid resins and polyvinyl alcohol resins are preferably used. In the water feeding means, water may be fed directly to the contact ring 6 for water feeding via the water feeding tube 4 from the water feeding pump without using the water feeding ring 5.

The water recovery means has a downstream water recovery ring 7 arranged at a position toward the antigravity direction from the contact ring 6 for water feeding, a downstream water discharge tube 8 and a suction pump (not shown). The downstream water recovery ring 7 is cyclic and at least the surface member thereof is made of a water-absorbing material. Such a downstream water recovery ring 7 is brought into contact with the peripheral surface of a tubular film at a position distant by given distance toward the antigravity direction from the contact ring 6 for water feeding, preferably with the peripheral surface of a tubular film at a position distant by 10 to 500 mm toward the antigravity direction from the contact ring 6 for water feeding, and recovers water remaining on the peripheral surface of the tubular film. As the water-absorbing material constituting at least the surface member of the downstream water recovery ring 7, the same material as the water-absorbing material used for the above-described contact ring 6 for water feeding can be used. Water recovered by the downstream water recovery ring 7 is removed from the downstream water recovery ring 7 by a suction pump connected to the downstream water recovery ring 7 via the downstream water discharge tube 8.

When water drips off from the contact ring 6 for water feeding, a cyclic upstream water recovery ring 9 may be arranged at a position toward the gravity direction from the contact ring 6 for water feeding, thereby recovering excess water. The upstream water recovery ring 9 is arranged so that it does not come into contact with a tubular film. Water recovered from the upstream water recovery ring 9 is removed from the upstream water recovery ring 9 by a suction pump connected to the upstream water recovery ring 9 via an upstream water discharge tube 10. The surface member of the upstream water recovery ring 9 is preferably made of a water-absorbing material from the standpoint of improvement in the efficiency of water recovery. When water recovery is difficult only with the upstream water recovery ring 9, a recovery ring having a V-shaped or U-shaped ditch may be further provided at a position toward the gravity direction from the above-described upstream water recovery ring. It is also possible to use a recovery ring 11 having a V-shaped or U-shaped ditch instead of the above-described upstream water recovery ring.

The apparatuses shown in FIGS. 1 and 2 have water recovery means situated at a position toward the gravity direction from the contact ring 6 for water feeding, namely, the upstream water recovery ring 9 and the upstream water discharge tube 10, and water recovery means situated at a position toward the antigravity direction from the contact ring 6 for water feeding, namely, the downstream water recovery ring 7 and the downstream water discharge tube 8. Though it is preferable that the apparatus used in the present invention thus has water recovery means at positions toward the antigravity direction and the gravity direction from the contact ring 6 for water feeding, a water recovery means may be provided at only either one position.

In the present invention, a water-absorbing material containing water and having a width in the gravity direction of 5 mm or more is brought into contact with the peripheral surface of a tubular film to cool the film, at any position distant by 0 to 200 mm toward the gravity direction from the frost line obtained by air cooling (hereinafter, referred to as air-cooled frost line). It is preferable from the standpoint of enhancement of the transparency of the film that the water-absorbing material is brought into contact with the peripheral surface of a tubular film to cool the film, at any position distant by 0 to 50 mm toward the gravity direction from the air-cooled frost line. It is preferable from the standpoint of reduction of irregularity of thickness (uneven thickness) of the film that the water-absorbing material is brought into contact with the peripheral surface of a tubular film to cool the film, at any position distant by 0 to 20 mm toward the gravity direction from the air-cooled frost line. Further, it is preferable that the water-absorbing material is brought into contact with the peripheral surface of a tubular film to cool the film, at any position distant by 0 to 10 mm. Here, the air-cooled frost line denotes a position at which a tubular film solidifies by air cooling such as cooling by an atmosphere in which the tubular film is molded, cooling by blowing of air to the peripheral surface of the tubular film, and the like, without effecting water-cooling of the tubular film in molding of the polyolefin resin film (however, the conditions for air cooling of the tubular film are not changed between the case of water cooling and the case of no water cooling).

The width of the water-absorbing material to be brought into contact with the peripheral surface of a tubular film is preferably 5 mm or more, more preferably 10 mm or more from the standpoint of enhancement of the transparency of the film. It is preferably 100 mm or less, more preferably 80 mm or less and further preferably 50 mm or less from the standpoint of enhancement of the appearance of the film such as reduction of wrinkle, and the like.

Regarding the molding conditions of the present invention, the temperature of water to be fed to a tubular film by a water-cooling apparatus is usually 5 to 40° C., and the flow rate of water is appropriately adjusted so as to obtain satisfactory transparency, depending on the extrusion amount of a polyolefin, the molding temperature, and the size of a molding processor. The molding temperature (extrusion temperature) is usually 130 to 250° C., and the blow up ratio is usually 1 to 5. The receiving speed is usually 5 to 150 m/min., and the air-cooled frost line is usually distant by 100 to 1000 mm toward the antigravity direction from a circular die.

The thickness of the film obtained in the present invention is usually 5 to 200 μm, preferably 10 to 150 μm, more preferably 20 to 100 μm.

The polyolefin resin to be used in the present invention is a resin containing monomer units based on olefin in an amount of 50 wt % or more, and mentioned are polyethylene resins, polypropylene resins, polybutene resins and the like. As the polyolefin resin, polyethylene resins are suitably used, and mentioned are high pressure low density polyethylene, high density polyethylene, ethylene-α-olefin copolymer, ethylene-vinyl ester copolymer, ethylene-unsaturated carboxylate copolymer, and the like. Of them, the ethylene-α-olefin copolymer and high density polyethylene are suitably used.

As the α-olefin in the above-described ethylene-α-olefin copolymer, those containing 3 to 20 carbon atoms are suitably used. The α-olefins containing 3 to 20 carbon atoms include propylene, 1-butene, 1-pentene, 1-hexene, 1-heptene, 1-octene, 1-nonene, 1-decene, 1-dodecene, 4-methyl-1-pentene, 4-methyl-1-hexene and the like, and these may be used singly or in combination of two or more. Preferable are 1-butene and 1-hexene.

Examples of the above-described ethylene-α-olefin copolymer include an ethylene-propylene copolymer, ethylene-1-butene copolymer, ethylene-1-hexene copolymer, ethylene-1-octene copolymer, ethylene-1-butene-1-hexene copolymer, ethylene-1-butene-1-octene copolymer and the like, and preferable are an ethylene-1-butene copolymer, ethylene-1-hexene copolymer and ethylene-1-butene-1-hexene copolymer.

The content of monomer units based on ethylene in the above-described ethylene-α-olefin copolymer is usually 50 to 99 wt % with respect to the total weight (100 wt %) of the ethylene-α-olefin copolymer. The content of monomer units based on α-olefin is usually 1 to 50 wt % with respect to the total weight (100 wt %) of the ethylene-α-olefin copolymer.

The melt flow rate (MFR) of the above-described ethylene-α-olefin copolymer measured under conditions of a temperature of 190° C. and a load of 21.18 N defined in JIS K7210 is usually 0.01 to 100 g/10 min. It is preferably 0.05 g/10 min. or more, more preferably 0.07 g/10 min. or more from the standpoint of enhancement of extrusion moldability. It is preferably 10 g/10 min. or less, more preferably 7.0 g/10 min. or less and further preferably 5.0 g/10 min. or less from the standpoint of enhancement of the strength of a film.

The density of the above-described ethylene-α-olefin copolymer is usually 890 to 970 kg/m³. It is preferably 910 kg/m³ or more, more preferably 920 kg/m³ or more from the standpoint of enhancement of the rigidity of a film. It is preferably 945 kg/m³ or less, further preferably 935 kg/m³ or less from the standpoint of enhancement of the transparency of a film. This density is measured according to a method defined in JIS K7112 using a sample subjected to annealing described in JIS K6760.

As the method of producing the polyolefin resin to be used in the present invention, production methods according to known polymerization methods using known radical polymerization catalysts and ion polymerization catalysts are mentioned. Examples of known catalysts include peroxide catalysts, Ziegler-Natta catalysts, metallocene catalysts and the like, and examples of known polymerization methods include a solution polymerization method, slurry polymerization method, high pressure ion polymerization method, high pressure radical polymerization method, gas phase polymerization method and the like.

As the polyolefin resin to be used in the present invention, ethylene-α-olefin copolymers produced by gas phase polymerization methods using metallocene catalysts are preferable. As the ethylene-α-olefin copolymer, specifically mentioned are ethylene-α-olefin copolymers described in JP-A No. 9-183816.

The polyolefin resin to be used in the present invention may contain other additives such as antioxidants, anti-blocking agents, slipping agents, anti-static agents, pigments, processing improvers and the like; other resins, and the like, and the additives and other resins may be used singly or in combination of two or more.

The above-described antioxidants include phenol antioxidants, phosphorus-based antioxidants and the like. These may be used each singly, or in combination of two or more.

Examples of the phenol antioxidant include 2,6-di-t-butyl-4-methyl-phenol (BHT), n-octadecyl-3-(3,5-di-t-butyl-4-hydroxyphenyl) propionate (trade name: Irganox 1076, manufactured by Chiba Specialty Chemicals Co., Ltd.), pentaerythrityl-tetrakis[3-(3,5-di-t-butyl-4-hydroxyphenyl) propionate] (trade name: Irganox 1010, manufactured by Chiba Specialty Chemicals Co., Ltd.), 1,3,5-tris(3,5-di-tert-butyl-4-hydroxybenzyl) isocyanurate (trade name: Irganox 3114, manufactured by Chiba Specialty Chemicals Co., Ltd.), 1,3,5-trimethyl-2,4,6-tris(3,5-di-t-butyl-4-hydroxybenzyl)benzene, 3,9-bis[2-{3-(3-t-butyl-4-hydroxy-5-methyl-phenyl)propionyloxy}-1,1-dimethyl-ethyl]-2,4,8,10-tetraoxaspiro[5-5]undecane (trade name: Sumilizer GA80, manufactured by Sumitomo Chemical Co., Ltd.) and the like.

Examples of the phosphorus-based antioxidant include distearylpentaerythritol diphosphite (trade name: ADEKATAB PEP8, manufactured by ADEKA), tris(2,4-di-t-butyl-phenyl) phosphate (trade name: Irgafos 168, manufactured by Chiba Specialty Chemicals Co., Ltd.), bis(2,4-di-t-butyl-phenyl)pentaerythritol diphosphite, tetrakis(2,4-di-t-butyl-phenyl)4,4′-biphenylene diphosphonite (trade name: Sandostab P-EPQ, manufactured by Clariant Japan K.K.), bis(2-t-butyl-4-methyl-phenyl)pentaerythritol diphosphite, 2,4,8,10-tetra-t-butyl-6-[3-(3-methyl-4-hydroxy-5-t-butyl-phenyl)propoxy]dibenzo[d,f][1,3,2]dioxaphosphepin (trade name: Sumilizer GP, manufactured by Sumitomo Chemical Co., Ltd.) and the like.

The above-described anti-blocking agent include inorganic anti-blocking agents and organic anti-blocking agents. Examples of the inorganic anti-blocking agents include silica, diatomaceous earth, talc, alumino silicate, kaolin, calcium carbonate, and the like. Examples of the organic anti-blocking agents include EPOSTAR-MA (manufactured by Nippon Shokubai Co., Ltd.).

Examples of the above-described slipping agent include higher fatty amides, higher fatty esters and the like.

Examples of the above-described anti-static agent include glycerin esters and sorbitan esters of fatty acids having 8 to 22 carbon atoms, alkyldialkanolamides of fatty acids having 8 to 22 carbon atoms, polyethylene glycol esters, alkyldiethanolamines and the like.

Examples of the above-described pigment include white pigment, carbon black and the like.

The above-described other resins include thermoplastic resins such as polyesters, polyamides, polycarbonates, polyurethanes, elastomers and the like.

A blend of the above-described additives, other resins and the like with a polyolefin resin is produced by melt kneading by known methods, for example, by mixing them by a tumbler mixer, Henschel mixer and the like, then, further performing granulation by melt kneading by a single screw extruder or multi screw extruder, or performing melt kneading by a kneader, Banbury mixer and the like.

### EXAMPLES

The present invention will be illustrated below by examples and comparative examples.

Physical properties in examples and comparative examples were measured according to the following methods.

### I. Physical Properties of Polyolefin Resin

(1) Melt flow rate (MFR, unit: g/10 min.)

The melt flow rate was measured under conditions of a load of 21.18 N and a temperature of 190° C. according to a method defined in JIS K7210.

(2) Density (unit: kg/m³)

The density was measured according to a method defined in method A in JIS K7112. A sample was subjected to annealing described in JIS K6760.

### II. Physical Properties of Inflation Film

(1) HAZE (unit: %)

The haze was measured according to a method defined in ASTM D1003. Smaller this value, more excellent transparency thereof.

(2) Gloss (unit: %)

The gloss was measured according to a 45° mirror surface gloss measuring method defined in JIS Z8741. Larger this value, more excellent gloss thereof.

### Example 1

An upward air-cooling mode inflation molding apparatus manufactured by PLACO Co., Ltd. having a 50 mmφ extruder, circular die (lip diameter: 125 mm, lip opening: 2.0 mm), air ring apparatus and receiver was equipped with a water-cooling apparatus as shown in FIG. 1, that is, a water-cooling apparatus having a water feeding means having a water feeding tube, water feeding ring and contact ring for water feeding, and a water removal means having a downstream water recovery ring, downstream water discharge tube, upstream water recovery ring and upstream water discharge tube. On the contact ring for water feeding, a polyester-based nonwoven fabric sheet having a width of 30 mm (strong dew condensation water-absorbing tape 30 silver E 101, manufactured by NITOMS Inc.) was wound as a water-absorbing material.

An ethylene•1-hexene copolymer (marketed by Sumitomo Chemical Co., Ltd., manufactured by Nippon Evolue K.K., trade name: Sumikathene-E FV203 (hereinafter, referred to as PE-1)) produced with a metallocene catalyst was used to initiate molding of an inflation film having a thickness of 50 μm under conditions of a processing temperature of 170° C., an extrusion amount of 25 kg/hr, a blow up ratio of 1.8 and a receiving speed of 12 m/min., under situation wherein the contact ring for water feeding, downstream water recovery ring and upstream water recovery ring were separated from the tubular film, while adjusting the air-cooled frost line to a position distant by 250 mm toward the antigravity direction from the circular die. Subsequently, water of normal temperature was fed at a flow rate of 3.5 liter/min. from the water feeding tube, and the contact ring for water feeding having a width of 30 mm was brought into contact with the tubular film at a position distant by 5 to 35 mm toward the gravity direction from the air-cooled frost line, thereby attaining water-cooling of the tubular film. The upper end of the upstream water recovery ring (end part on the antigravity direction) was situated at a position distant by 5 mm toward the gravity direction from the lower end of the contact ring for water feeding (end part on the gravity direction), and excess water over-flown from the contact ring for water feeding was recovered, and the lower end of the downstream water recovery ring (end part on the gravity direction) was set at a position distant by 350 mm toward the antigravity direction from the air-cooled frost line and excess water adhered to the tubular film was recovered. The results of evaluation of the physical properties of the resultant film are shown in Table 1.

### Example 2

The same procedure as in Example 1 was carried out excepting that an ethylene•1-hexene copolymer (manufactured by Sumitomo Chemical Co., Ltd., trade name: Sumikathene α CS8051 (hereinafter, referred to as PE-2)) produced with a Ziegler catalyst was used instead of PE-1. The results of evaluation of the physical properties of the resultant film are shown in Table 1.

### Example 3

The same procedure as in Example 1 was carried out excepting that an ethylene•1-butene copolymer (manufactured by Sumitomo Chemical Co., Ltd., trade name: Sumikathene-L CL1079 (hereinafter, referred to as PE-3)) produced with a Ziegler catalyst was used instead of PE-1, and the processing temperature was changed to 190° C. The results of evaluation of the physical properties of the resultant film are shown in Table 1.

### Example 4

The same procedure as in Example 1 was carried out excepting that an ethylene•1-butene copolymer (manufactured by Sumitomo Chemical Co., Ltd., trade name: Sumikathene-L FS150C (hereinafter, referred to as PE-4)) produced with a Ziegler catalyst was used instead of PE-1, and the processing temperature was changed to 190° C. The results of evaluation of the physical properties of the resultant film are shown in Table 1.

### Comparative Example 1

The same procedure as in Example 1 was carried out excepting that a water-cooling apparatus was not used. The results of evaluation of the physical properties of the resultant film are shown in Table 2.

### Comparative Example 2

The same procedure as in Example 2 was carried out excepting that a water-cooling apparatus was not used. The results of evaluation of the physical properties of the resultant film are shown in Table 2.

### Comparative Example 3

The same procedure as in Example 3 was carried out excepting that a water-cooling apparatus was not used. The results of evaluation of the physical properties of the resultant film are shown in Table 2.

### Comparative Example 4

The same procedure as in Example 4 was carried out excepting that a water-cooling apparatus was not used. The results of evaluation of the physical properties of the resultant film are shown in Table 2.

### Comparative Example 5

The same procedure as in Example 1 was carried out excepting that the position of contact of the upper end of the contact ring for water feeding with the tubular film was changed to a position distant by 210 mm toward the gravity direction from the air-cooled frost line and the contact position of the downstream water recovery ring with the tubular film was changed to a position distant by 220 mm toward the gravity direction from the air-cooled frost line. As a result, the tubular film melt-extruded from the circular die vibrated widely, and the thickness of the resultant film was irregular.

### Comparative Example 6

The same procedure as in Example 1 was carried out excepting that the position of contact of the lower end of the contact ring for water feeding with the tubular film was changed to a position distant by 3 mm toward the antigravity direction from the air-cooled frost line. The resultant film was a film showing significant irregularity in transparency (transparent parts and non-transparent parts are present).

TABLE 1

| | | Example | Example | Example | Example |
|---|---|---|---|---|---|
| | | 1 | 2 | 3 | 4 |
| Polyolefin resin | | | | | |
| Resin | | PE-1 | PE-2 | PE-3 | PE-4 |
| MFR | g/10 | 2 | 2 | 0.8 | 0.8 |
| | min. | | | | |
| Density | kg/m³ | 912 | 940 | 915 | 923 |
| Film physical | | | | | |
| properties | | | | | |
| HAZE | % | 5.1 | 13.9 | 5.7 | 3.7 |
| Gloss | % | 116 | 110 | 129 | 126 |

TABLE 2

| | | Compara- | Compara- | Compara- | Compara- |
|---|---|---|---|---|---|
| | | tive | tive | tive | tive |
| | | Example 1 | Example 2 | Example 3 | Example 4 |
| polyolefin resin | | | | | |
| Resin | | PE-1 | PE-2 | PE-3 | PE-4 |
| MFR | g/10 | 2 | 2 | 0.8 | 0.8 |
| | min. | | | | |
| Density | kg/m³ | 912 | 940 | 915 | 923 |
| Film physical | | | | | |
| properties | | | | | |
| HAZE | % | 49.0 | 49.3 | 17.1 | 15.5 |
| Gloss | % | 17 | 17 | 64 | 73 |

### INDUSTRIAL APPLICABILITY

The present invention can provides a method of producing a polyolefin resin film comprising melt-extruding a polyolefin resin from a circular die toward the antigravity direction to form a tubular film and cooling the tubular film while receiving the film toward the antigravity direction, thereby obtaining a film excellent in transparency.

1. A method of producing a polyolefin resin film comprising melt-extruding a polyolefin resin from a circular die toward the antigravity direction to form a tubular film and cooling the tubular film while receiving the film toward the antigravity direction, wherein a water-absorbing material containing water and having a width in the gravity direction of 5 mm or more is brought into contact with the peripheral surface of the tubular film to cool the film, at any position distant by 0 to 200 mm toward the gravity direction from the frost line obtained by air cooling.

2. The method of producing a polyolefin resin film according to claim 1, wherein, further, a water recovery means is arranged at a position toward the gravity direction from the position of contact of the water-absorbing material containing water with the peripheral surface of the tubular film, and the water recovery means recovers water fed to the peripheral surface of the tubular film from said water-absorbing material.

3. The method of producing a polyolefin resin film according to claim 1, wherein, further, a water recovery means is arranged at a position toward the antigravity direction from the position of contact of the water-absorbing material containing water with the peripheral surface of the tubular film, and the water recovery means recovers water fed to the peripheral surface of the tubular film from said water-absorbing material.

4. The method of producing a polyolefin resin film according to any one of claims 1 to 3, wherein the polyolefin resin is a polyethylene resin.
